(19) United States
(12) Patent Application Publication
(10) Pub. No.: US 2003/0169851 A1
(43) Pub. Date: Sep. 11, 2003

(54) Interference suppression procedure for a superordinate nmc by correlation of alarms with results of automatic tests

(76) Inventor: Lucian Hirsch, Munchen (DE)

Correspondence Address: STAAS & HALSEY LLP, SUITE 700, 1201 NEW YORK AVENUE, N.W., WASHINGTON, DC, 20005, US

(21) Appl. No.: 10/333,781

(22) PCT Filed: Jul. 4, 2001
(86) PCT No.: PCT/DE01/02479

(30) Foreign Application Priority Data
Jul. 24, 2000 (DE) 100 35 966.3

(51) Int. Cl. H04M 3/22

(52) U.S. Cl. 379/33

(57) ABSTRACT

The invention relates to an operation and maintenance center (OMC 7) that comprises a test device (8) which initiates, if alarm notifications (1) are received by the OMC (7), a test in response to said alarm in the hardware (5) of the telecommunications network (6) associated with said alarm, and transmits the results of said test to a superordinate national maintenance center (NMC 10) indicating the components which are affected by said alarm notification (1). The test is carried out in the OMC (7) according to a table (11), taking into consideration the manufacturer-specific peculiarities of the hardware (5) affected by the error notification (1).

The invention relates to methods and apparatuses for processing alarm messages in a telecommunications network, in particular for processing alarm messages which arrive at an OMC, by means of an NMC in a mobile telecommunications network.

By way of example, it is known from the textbook “GSM—Switching services and protocols” by Jörg Eberspächer, ISBN0-471-98278-4, pages 231 to 232, for a digital mobile telecommunications network to be provided not only with monitoring centers (OMC, operation and maintenance centers) which are arranged locally at a number of points in the mobile telecommunications network, but also with at least one monitoring center (NMC, National Maintenance Center) which is functionally superordinate to these local monitoring centers. The superordinate monitoring center NMC automatically carries out monitoring and maintenance functions on behalf of local monitoring centers OMC, for example at the weekend and on public holidays, in particular to the extent that the OMC monitoring centers are not manned, at least at times, at the weekend and on public holidays.

One NMC thus monitors a number of OMCs which are connected to hardware from generally different manufacturers via a common functional interface. Since the interface, which is independent of the manufacturer, between the OMC and NMC knows only so-called functional managed objects (FMO), manufacturer-specific and hardware-related details at this interface thus not being possible, alarms which have been generated by hardware faults in elements in a telecommunications network and which arrive at an OMC are converted by the OMC to alarms in the FMO format, which are passed as alarm notifications to an NMC (alarms are in principle passed to the NMC, however, only at specific times such as weekends etc. for handling in the NMC). Repair measures for hardware in the local area of a regional OMC are initiated by the NMC at weekends and on public holidays, since the regional OMCs are not manned at this time.

Certain hardware faults can admittedly in principle also be overcome by means of appropriate “tests” without any servicing personnel, but it is generally impossible for an NMC to do this since the NMC generally has no detailed knowledge of the various hardware (different manufacturers) in the area of the regional OMCs and therefore does not have any of the tests which are suitable for this manufacturer-specific hardware, either.

The object of the present invention is for alarm messages to be handled in as simple and efficient a manner as possible by an NMC for alarm messages, when such alarm messages arrive at an OMC at times at which these alarm messages need to be processed by the NMC. The object is in each case achieved by the subject matters of the independent claims.

When a “test” relating to the cause of the arriving alarm message is started initially automatically (at least in specified alarm situations) for alarms which according to the invention arrive in an OMC from hardware which is arranged regionally and is supervised by the OMC, some alarm messages can be sorted out just on the basis of the “test”, especially if the test comprises a specific automatic rectification procedure for the alarm message. Furthermore, in the case of alarm messages which are intended to be sent to a superordinate monitoring center (NMC) after the test has been carried out, test results obtained from the test which has carried out automatically can also be transmitted in order to make it possible for the NMC to initiate more precisely matched suitable measures without the NMC needing to know the details of the hardware which initiates the alarm message in the area of that OMC.

Particularly advantageous refinements are specified in the dependent claims.

The test expediently includes correlation of the alarm messages that arrive at the OMC with further alarm messages (for an investigation which was carried out in the course of the test into the hardware that initiated the alarm message) and other messages, in particular test result messages.

A test is expediently started automatically by the OMC only for a predetermined type of alarms, which are included in a list, which is to be compared with arriving alarm messages, in the OMC.

The method is preferably carried out only for types of hardware alarms which are classified as being critical on the basis of a table in the OMC. The use of critical hardware alarms relating to a table in the OMC makes it possible for the OMC to take account of the manufacturer-specific configuration of the hardware in the area of that OMC.

When hardware which has initiated the alarm message is being investigated in the course of the test, this hardware (elements of the mobile telecommunications network) is expediently disconnected from the mobile communications network, and is tested independently of it. This allows very specific testing of the hardware elements by predetermined, manufacturer-specific test procedures which are coordinated, for example, via the OMC.

The invention may, according to the claims, be in the form of an apparatus, in particular at a local (regional) monitoring center (OMC).

Further features and advantages will become evident from the following description of an exemplary embodiment and with reference to the drawing, in which:

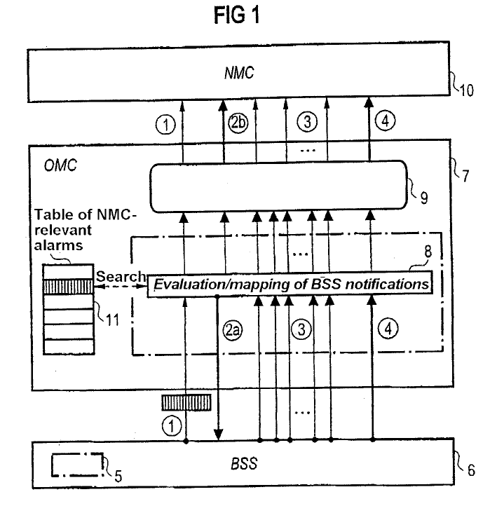

FIG. 1 shows an NMC, OMC and BSS while processing an alarm message according to the invention, and

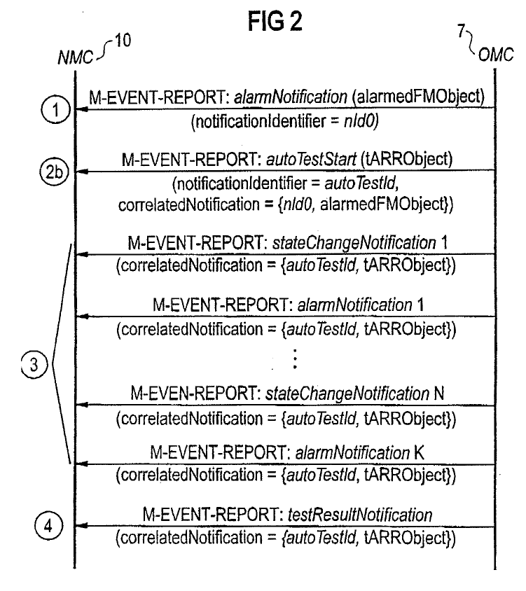

FIG. 2 shows parts of the communication between an NMC and an OMC while processing an alarm message according to the invention.

As shown in FIG. 1, a hardware fault in a hardware element 5 in a base station subsystem (BSS) in a digital mobile communications network (for example in accordance with the GSM, UMTS or another Standard) results in an alarm message 1 being sent (in a manner which is already known per se for example from GSM or other Standards) from the base station subsystem (6) to a monitoring center (OMC=operation and maintenance center) (7). This incoming alarm message is processed in the monitoring center OMC (7) by a test device (8) according to the invention. This is done by the test device (8) first of all transmitting, in a manner known per se (for example known from GSM) the alarm (1) (via one of the NMC's own EFD instances 9) to a monitoring center (NMC =National Maintenance Center 10), which is superordinate to the local monitoring center OMC, as a standardized further alarm message 1. In this case, the alarm message 1 is passed on in the normal way in the OMC (7, 8, 9) in accordance with a Table 11 in a further alarm message format which is specified for the transmission to the NMC (and which is very abstract and does not take any account of manufacturer-specific characteristics of the hardware 5).

Furthermore, according to the invention, the original alarm message (1) which arrived from the hardware of the BSS is analyzed (by the test device 8 in the local monitoring center OMC 7) for the configuration of a test. In the process, parameters of the original alarm message (1) which arrived from the hardware (5) of the BSS (6) are compared by the test device (8) with parameters (a number of predetermined types of NMC-relevant alarms) in a table (11) in the OMC (7, 8). If no entry with parameters corresponding to the original alarm message 1 from the BSS (6) are found in the table (11) , no test according to the invention is carried out for that alarm (1). If, however, an entry with the same or corresponding parameters as or to the parameters in the original alarm message (1) from the BSS is found in the table (11) in the local monitoring center OMC (7), a test (which includes a rectification procedure) according to the invention is initiated and is carried out by the test device (8) in the local monitoring center OMC (7). This is done by the test device (8) in the local monitoring center OMC (7) first of all sending a test request (2a) to the base station subsystem BSS (6) in the mobile communications network; this is done, by way of example, by means of a CMISE-standardized M-action relating to a resource self test (hardware test) corresponding to a test identification parameter for the table entry which corresponds to parameters in the original alarm message 1.

Furthermore, the local monitoring center OMC (7) sends a notification to the superordinate monitoring center NMC (10) informing the latter that it has initiated (2a) a hardware test in the hardware (5) of the base station subsystem (6), so that the NMC (10) is informed of the fact that further fault messages relating to the hardware (5) which may be initiated in the course of the test are due to the test and do not relate to further faults. The notification is in the form of a notification autonomous test start (2b in FIG. 1) message, for example in accordance with a Standard (ITU Standard TX.745: System Management: Test Management Function), with the field correlated notification (see the message 2b in FIG. 2) containing the value pair {nld0, alarmed FM object} from the original alarm message (1)

Once the test request (2a) has been received in the base station subsystem (6) a test environment is first of all prepared for the test; this is done, for example, by blocking a hardware board from hardware 5 which initiated the alarm message 1 {Parameter administrative state=locked). As a result of this, partially initiated by the hardware (5) in the BSS (6), further alarm messages to the OMC (7) are correlated by the OMC with the autonomous test start notification (=for example with a message relating to this added to it), and are then passed to the superordinate monitoring center NMC 10 in order to allow an NMC operator to identify the fact that these further alarms are a consequence of a hardware test which has already been started automatically and do not relate to real further hardware faults.

Once the test environment has been prepared, the test requested (2a) by the OMC is started in the BSS (6). At the end of the test, the results are sent as a standardized test result notification from the hardware (5) of the BSS (6) to the local monitoring center OMC (7). These results/parameters of the test are sent from the local monitoring center OMC (7) to the superordinate monitoring center NMC (10) (with these results/parameters being correlated with the previous autonomous test start notification 2b).

FIG. 2 shows the transmission of messages (as discussed with reference to FIG. 1) from the local monitoring center OMC (7-9) to the superordinate monitoring center NMC (10). Following the notifications (1) and (2b), which have already been mentioned with reference to FIG. 1, from the OMC (9) to the NMC (10), further notifications are produced at reference symbol (3) and reference symbol (4) , which the OMC (9) uses, after carrying out a test according to the invention, to inform the NMC (10) of the test results (as well as the test parameters). In this case, all the notifications which are annotated by the reference symbols (3) and (4) are directly correlated in the OMC (7) with the previous autonomous test start notification, by the respective field correlation notification receiving the value pair (notification Id, object instance) from the autonomous test start notification (that is to say {Autotest Id, tARRObject}).

Since, for its part, the autonomous test start notification is correlated with the original alarm notification (produces a reference to it), an indirect correlation is produced in the NMC (=reference to a relationship relating to the relevant hardware etc.) between the test results notification (4 in FIG. 2) and the further alarm message (1) from the OMC (9) to the NMC (10 in FIG. 2).

The invention can be used in telecommunications networks to widely differing Standards, for example in GSM, UMTS or other networks.

1. A method for processing alarm messages (1) in a telecommunications network, in particular for processing OMC alarm messages (1) in a mobile telecommunications network (6, 7, 10),
wherein a test for elements (5) of the telecommunications network (6) which are identified by the alarm message (1) is started (2a) by a local monitoring center (OMC 7) in the event of this local monitoring center (OMC 7) receiving an alarm message (1),
and a further alarm message (1) relating to the alarm message (1) which has been received is sent from the local monitoring center OMC (7) to a superordinate monitoring center (NMC 10).

2. The method as claimed in claim 1,
characterized in that the method is carried out only at predetermined times, in particular at weekends and on public holidays.

3. The method as claimed in one of the preceding claims,
characterized in that alarm messages (1) which arrive at the local monitoring center (OMC 7) and/or results (3, 4) which relate to a test carried out in response to this alarm message (1) are sent (3, 4) to the superordinate monitoring center (10) with a reference to the test.

4. The method as claimed in one of the preceding claims,
characterized in that the local monitoring center (OMC 7) automatically starts (2a) the test, at least for predetermined types (11) of alarms, without having to check with the superordinate monitoring center (NMC 10).

5. The method as claimed in one of the preceding claims,
characterized in that the method is carried out only for types of alarms (1) which are classified as being critical and are stored in a table (11) in the local monitoring center (OMC 7).

6. The method as claimed in one of the preceding claims,
characterized in that, once a test has been carried out, the local monitoring center (OMC 7) sends to the superordinate monitoring center (NMC 10) the results (4) of the test and the parameters which relate to the hardware (5) of the telecommunications network (6) which initiated the original alarm message (1), with a reference to the association of the test with the further alarm message (1) which has already been passed on.

7. The method as claimed in one of the preceding claims,
characterized in that the test attempts to overcome the cause of the alarm message, and in that a negative test result means that the local monitoring center has not been able to overcome the cause of the alarm message.

8. The method as claimed in one of the preceding claims,
characterized in that the hardware (5) which is named or can be identified by the alarm message (1) is disconnected from the telecommunications network (6) and is then tested automatically for the test for detection and/or overcoming of the cause of the alarm message (1).

9. The method as claimed in one of the preceding claims,
characterized in that, in the case of test results (4) which are signaled to the superordinate monitoring center (NMC 10), these test results (4) are indicated to an operator of the superordinate monitoring center (NMC) in order to allow rectification measures to be taken.

10. A test device for a monitoring center (OMC 7), in particular for carrying out the method as claimed in one of the preceding claims,
having an input (into 8) for defects, which relate to alarm messages (1), in elements (5) of a telecommunications network (6),
having a device (8) for initiating (2b) tests for elements (5) of the telecommunications network which can be identified by alarm messages (1), and
having an output device (9) for passing on alarm messages (1) and results (3, 4) of tests to a superordinate monitoring center (NMC 10).

11. The test device as claimed in claim 10, characterized in that the test device is designed such that messages are passed on to an NMC (10) only at predetermined times, in particular at weekends and on public holidays.

12. The test device as claimed in one of the preceding claims, characterized in that the test device is designed such that an alarm message (1) which arrives at the local monitoring center (OMC 7), and/or results (3/4) which relate to a test carried out in response to this alarm message (1) are sent (3, 4) to the superordinate monitoring center (10) with a reference to the test.

13. The test device as claimed in one of the preceding claims, characterized in that the test device is designed such that the local monitoring center (OMC 7) automatically starts (2a) the test, at least for predetermined types (11) of alarms, without having to check with the superordinate monitoring center (NMC 10).

14. The test device as claimed in one of the preceding claims, characterized in that the test device has a table (11) of alarms which are classified as being critical and for which alarms only one test is to be initiated.

15. The test device as claimed in one of the preceding claims, characterized in that the test device is designed such that, after the local monitoring center (OMC 7) has carried out a test, the results (4) of the test and parameters which relate to the hardware (5) of the telecommunications network (6) which initiated the original alarm message are sent to the superordinate monitoring center (NMC 10), with a reference to the association of the test with the further alarm message (1) which has already been passed on.

16. The test device as claimed in one of the preceding claims, characterized in that the test device is designed such that the test attempts to overcome the cause of the alarm message, and such that a negative test result means that the local monitoring center has not been able to overcome the cause of the alarm message.

17. The test device as claimed in one of the preceding claims,
characterized in that the test device is designed such that the hardware (5) which is named or can be identified by the alarm message (1) is disconnected from the telecommunications network (6) and is tested independently of the telecommunications network for the test for detection and/or overcoming of the cause of the alarm message (1).

18. The test device as claimed in one of the preceding claims,
characterized in that the test device is designed such that, in the case of test results (4) which are signaled to the superordinate monitoring center (NMC 10), these test results (4) are indicated to an operator of the superordinate monitoring center (NMC 10) in order to allow rectification measures to be taken.
